(19) United States
(12) Patent Application Publication
(10) Pub. No.: US 2009/0235562 A1
(43) Pub. Date: Sep. 24, 2009

(54) DISPLAY BOARD WITH INTEGRATED CARD HOLDER AND RELATED METHOD OF MANUFACTURE

(75) Inventors: Wallace A. Krapf, Macedon, NY (US); John Deats, Brockport, NY (US)

Correspondence Address: Hiscock & Barclay, LLP, One Park Place, 300 South State Street, Syracuse, NY, 13202-2078, US

(73) Assignee: W.A. Krapf, Inc., Macedon, NY (US)

(21) Appl. No.: 12/408,760

(22) Filed: Mar. 23, 2009

Related U.S. Application Data
(60) Provisional application No. 61/038,498, filed on Mar. 21, 2008.

(51) Int. Cl. G09F 1/10; B43L 1/00; B23P 15/00

(52) U.S. Cl. 40/124; 434/408; 29/592

(57) ABSTRACT

A display board is defined by a front panel, a rear panel and material sandwiched between the front and rear panels. The front panel includes at least one card-holding portion that includes a plurality of slotted portions sized for retaining at least one card and in which the backing material includes at least one recess that is sized and indexed with the slotted portions of the at least one card-holding portion.

### CROSS REFERENCE TO RELATED APPLICATION

This patent application claims priority to a provisional patent application Ser. No. 61/038,498, filed Mar. 21, 2008, pursuant to 35 U.S.C. §§111 and 119, the entire contents of said application being incorporated by reference herein.

### FIELD OF THE INVENTION

The application relates to the field of display systems and in particular to a display board having at least one integrated card holder, as well as a related method of manufacturing a display board that integrates at least one card holder therein.

### BACKGROUND OF THE INVENTION

Presently, there are known card holders that are used in manufacturing, industrial, and other related fields for various purposes, such as tracking attendance or location of employees. For example, time cards are collected for a group of related individuals, such as employees in a factory, industrial plant, laboratory or other facility and retained in a card holder disposed in relation to a time punch. A portion of each card extends outwardly for reasons of identifying the card for example for purposes of displaying specific information (e.g., employee names). In one previously known version, card holders have been developed within a dedicated metallized frame structure wherein the structure further includes a plurality of spaced longitudinal slots. Cards are retained within each of the slots wherein a portion of an inserted card extends therefrom and is visible for display or card filing purposes, such as for time cards, job stations, tool control, calendaring and other functions as may be appropriate.

There are other situations and potential applications in which it would be preferred to provide other display aspects, apart from those that are provided by the cards themselves, in a common form.

### SUMMARY OF THE INVENTION

Therefore and according to one aspect, there is provided a display board including a front panel, a rear panel and at least one card-holding portion directly integrated into the front panel of said display board. In one version, substrate material is disposed between the front panel and the rear panel of the display board, wherein the substrate material includes a plurality of cavities or recesses that correspond in number and dimension to the number of card-holding portions provided on the front panel. The at least one card-holding portion includes a plurality of spaced slots provided in a louvered or other convenient configuration, each slot being sized to receive a portion of a card. Each of the slots/cavities are appropriately sized for retaining at least a portion of a card.

Each card-holding portion of the display board is manufactured with a plurality of spaced slots that are sized to accommodate a card disposed within the card-holding portion. A plurality of slotted portions of varying size and width can be created for placement and provide considerable versatility of varying types of display board, such as, for example, a magnetic dry-erase board.

According to another aspect, there is described a method of manufacturing a display board, said method comprising the steps of: providing a front panel and a backing substrate, forming at least one cavity in said backing substrate and forming at least one card holding portion in said front panel wherein said card holding portion includes at least one column of louvered slots, said at least one card holding portion being indexed with said at least one cavity of said substrate and assembling said front panel to said substrate, said front panel including a display portion along with said at least one carding portion thereby creating an display board with an integrated card holder.

One advantage provided herein is that the herein described method of manufacture permits considerable variety in the forms of display board that can be provided wherein the manufacture is not significantly time, labor or cost intensive.

Another advantage realized is that variability in the number of card holding portions is also integrally permitted in display systems.

Yet another advantage is that a manufacturing process is provided that permits a display board to be fabricated and easily assembled with any convenient number of card-holding portions, allowing the remainder of the board to be used for other purposes, such as display, calendaring, etc.

These and other features and advantages will become readily apparent from the following Detailed Description, which should be read in conjunction with the accompanying drawings.

### BRIEF DESCRIPTION OF THE DRAWINGS

FIG. 1 is a front facing view of a card holding apparatus in accordance with the prior art;

FIG. 2 is an exploded front perspective view of a display board that is manufactured in accordance with one embodiment;

FIG. 3 is a side elevational view, taken in section, of the display board of FIG. 2;

FIG. 4 is a front facing view of a card holding apparatus that is manufactured in accordance with a second embodiment; and

FIG. 5 is a partially exploded view of a display board that is manufactured in accordance with a third embodiment, including a schematic representation as to the formation of certain elements of the display board.

### DETAILED DESCRIPTION

The following description relates to various embodiments of a display board with an integrated card holder and more particularly in conjunction with a magnetic dry-erase display board. It will be readily apparent, however, that other variations and modifications are possible within the inventive aspects that are described in greater detail herein. In addition, a number of terms are used throughout for purposes of providing a suitable frame of reference with regard to the accompanying drawings. It is not intended that these terms shall in any way be limiting, however, except where so specifically indicated.

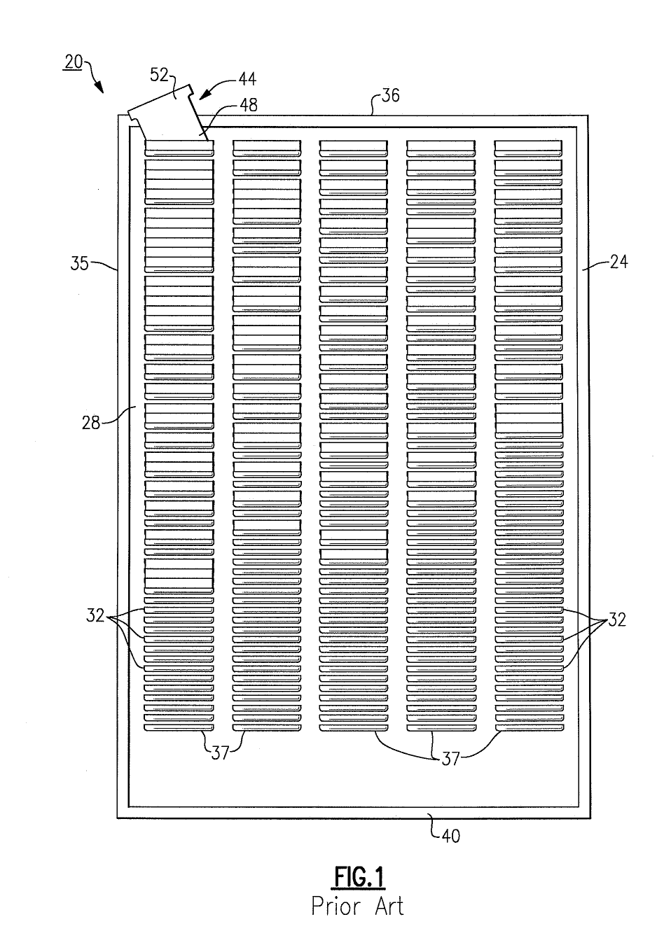

Referring to FIG. 1 and for reasons of providing a suitable background, there is shown a known card holding apparatus 20. The card holding apparatus 20 is constructed of a sheet-metal section 24 that is defined by a facing surface 28 and a plurality of inwardly bent side tab-like surfaces (not shown) forming lateral sides of the apparatus. This version is shown wherein the bent side tab-like surfaces are inserted into a frame 35, forming a border for the apparatus 20. A plurality of very closely spaced slots 32 are stamped or punched into the facing surface 28 of the facing surface 28 by means of a turret press or other forming apparatus (not shown) wherein the spaced slots 32 are disposed in a louvered pattern that is formed in a plurality of vertically defined slot columns 37 that are disposed in parallel spaced relation with each other. According to this embodiment, five (5) vertical columns 37, each column containing a plurality of closely spaced slots 32 are provided, although it will be readily apparent that this parameter can be suitably varied based on the size of the sheet metal section 24. Each of the columns 37 of slots 32 shown in this structure are spaced equally from one another between respective top and bottom sides 36, 40 of the facing surface 28 of the sheet metal section 24.

Each slot 32 is sized to permit a corresponding card 44 to be vertically placed within the slot and into a cavity (not shown) that is defined in the rear of the frame 24, enabling each card to be stored without folding or tearing. The cards 44, referred to hereinafter as “T-cards”, are each defined by a major rectangular portion 48 and a smaller extending top portion 52. The extending top portion 52 of each T-card 44 has a width dimension that is larger than the major portion 48 of the card, this dimension also being larger than that of the spaced slots 32. This particular sizing enables the major portion 48 of a T-card 44 to be fitted into a selected one of the slots 32 with the extending top portion 52 being visible upon insertion above the slot. As such, various information can be included on each of the major and extending portions 48, 52 of the T-card 44, for example, wherein identifying information can be included on the extending top portion 52 and more detailed information on the major portion 48. In the present example, the number of columns 37 can be varied to provide some versatility, but the card holder apparatus 20 themselves are used more or less as dedicated apparatus.

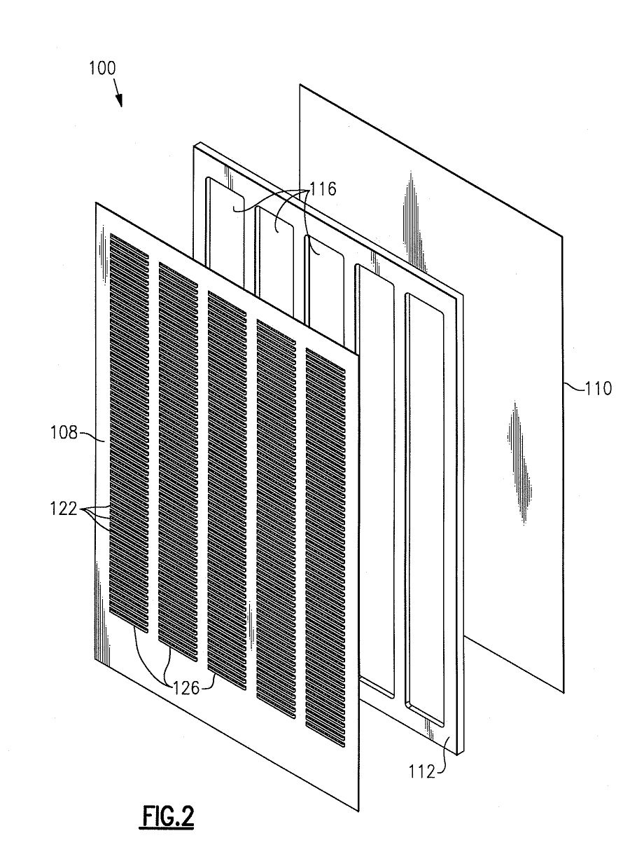

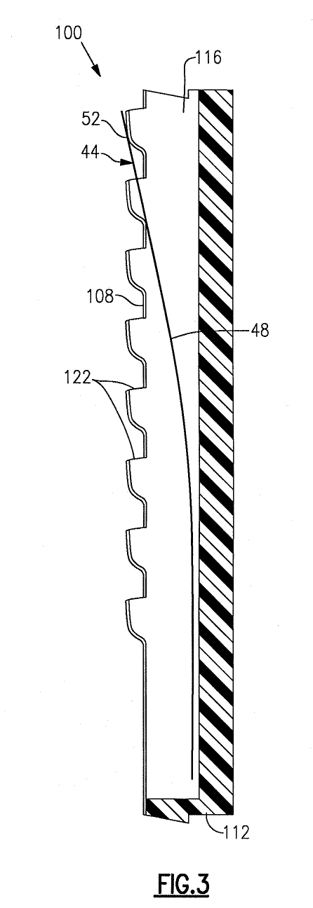

With the preceding background and turning to FIGS. 2 and 3, there is depicted a display board 100 made in accordance with a first embodiment. The display board 100 according to this embodiment is defined by a multi-layered assemblage including a front panel 108 and a backing or rear panel 110. According to this specific embodiment, a substrate material 112, such as a plastic or rubber structural foam, is sandwiched between the front and rear panels 108, 110. According to this design, the front panel 108 of the display board 100 is defined by a thin sheet-steel and the rear panel 110 is similarly made from a somewhat thinner metal sheet material, although other materials, such as corrugated cardboard or other suitable material can be utilized. Optionally, a layer of corrugated cardboard or other backing material can also be provided between the sandwiched substrate material 112 and the rear panel 110. In certain other alternative versions, having a rear panel 110 is optional wherein substrate material 112 itself may be able to provide the necessary backing structure for the display board 100. As noted, the front panel 108 according to this embodiment is made from a sheet-steel material that permits magnetic attachment. In addition, the front facing surface of the front panel 108 is coated with a material, enabling use of the surface for display purposes. In a preferred version, the front facing surface is coated with Magnalux® manufactured by W. A. Krapf, Inc., or similar coatings, that enables use of this surface as a dry-erase surface for write-on and printing purposes. Applications for the latter feature will be further discussed in a later embodiment.

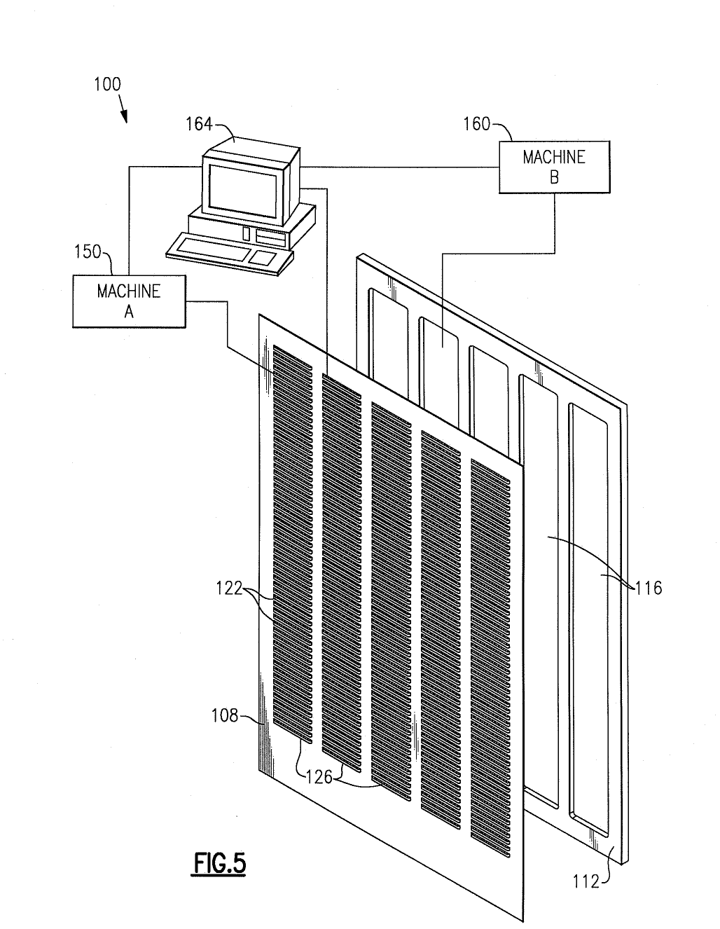

As shown in FIGS. 2 and 3, the front panel 108 includes a plurality of spaced slots 122 that are arranged in vertical columns 126, similar to that previously described in FIG. 1, for purposes of this discussion. Like the preceding, the slots 122 are stamped or pressed in a louvered pattern using a turret press or other forming machine, such as that shown schematically as 150 in FIG. 5. In this specific embodiment, five (5) columns of closely-spaced slots 122 are provided, although it will be readily apparent that this parameter can be suitably varied. Unlike the preceding, however, a front facing surface of the substrate material 112 is also provided with a corresponding number of vertically extending recesses 116 matching the number of slot columns 126 formed in the front panel 108. The recesses 116 are preferably indexed with the locations of the columns 126 of the spaced slots 122 of the front panel 108 and are appropriately sized in terms of their height and width dimensions with that of each column 126. Referring to FIG. 5, each of the recesses 116 are formed on an CNC router or other forming apparatus 160, although other forming apparatus can be used. Each of the router 160 and the turret press 150 are linked to one another by means of a common controller 164 according to this embodiment. Alternatively separate controllers could be used, though preferably the files for each of the front panel 108 and the substrate material 112 are used in conjunction with one another for indexing purposes. As such, the introduction of a T-card 44, as shown in FIG. 3, into a slot 122 allows the major extending portion 48 to be nested within the cavity 116 formed in the substrate material 112 without tearing, while the substrate material 112 provides structural support for the display board 100. As noted, the rear panel 110 is optional as well as a truss or other appropriate frame (not shown) that can be added to each lateral edge of the display board 100.

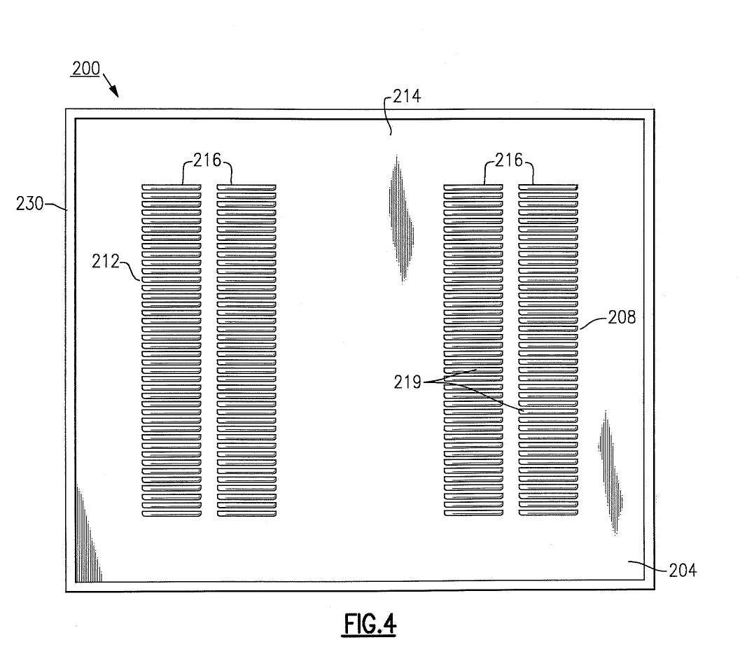

Referring to FIG. 4, it will be appreciated that considerable versatility is afforded by the concepts described herein wherein the herein described display board can include various uses and applications. For example, a display board 200 can be manufactured, the board including a front panel 204 having a pair of card-holding portions 208, 212 as well as a surface portion 214 that permits other display therebetween. In this version, the front panel 204 is made from a sheet-steel such as in the preceding in which the front facing side has also been coated with a dry-erase coating, such as Magnalux®, which permits write-on applications as well as preprinting of heat fused display lines or other indicia, as desired, depending on the application. As such, the front facing surface of the front panel 204 acts as a magnetic dry-erase display board for purposes of this embodiment.

Each of the card-holding portions 208, 212 according to this exemplary embodiment include a pair of vertically disposed columns 216, each having a louvered pattern of closely spaced slots 219. The two columns 216 of each card holding portion 208, 212 are provided on opposite sides of the front panel 208. A substrate material (not shown) but similar to that of 112, FIG. 2, is disposed beneath the front panel 204 and includes four (4) recesses 116, FIG. 2, that are sized and indexed in accordance with the locations of the columns 216 of the card holding portions 208, 212. In terms of manufacture, the substrate material and a rear panel (not shown) are then assembled with the edges of the front panel 204, rear panel and substrate material within a frame 230 that retains the sandwiched components in an integrated assemblage.

Various applications are possible using the herein described display board 200. For example, the front panel 204 can include various printed indicia or material (not shown) for the display portion 214 or for purposes of identifying the card-holding portions 208, 212, such as heat fused identification lines for scheduling, planning and visual control of information relating to the cards (not shown in this view). Display boards as described herein can also be provided as part of larger assemblies, for example, rotating kiosks that can include a plurality of display boards in cubic and other configurations. Such kiosks typically have bases and rotating display members including a plurality of display boards, wherein the herein described version can be provided as at least one of said display boards. According to yet another example, the front surface 214 of the front panel 204 can be printed by means of a dye-sublimation process in which material is directly added into the steel material for example, geographic maps or other media. Numerous other variations can be appreciated wherein this design is intended only to be exemplary.

### PARTS LIST FOR FIGS. 1-5

20 card holding apparatus
24 frame structure
28 facing surface
32 spaced slots
35 frame
36 top side
37 columns
40 bottom side
44 cards
48 major portion
52 top extending portion
100 display board
104 frame
108 front side or panel
110 rear side or panel
112 substrate material
116 recesses, plurality
122 slots
126 columns
150 forming machine, turret press
160 forming apparatus
164 controller
200 display board
204 front panel
208 card-holding portion
212 card-holding portion
214 display portion or surface
216 columns
219 slots
230 frame

It will be readily apparent that there are other variations and modifications that can be made, which include the concepts described and detailed herein. These and other modifications and variations will become readily apparent to those of sufficient skill in the field. For example and in lieu of a foam substrate material, other materials could be substituted in order to provide suitable backing for the front panel.

1. A display board comprising:
a front panel:
a rear panel; and
at least one card-holding portion directly integrated into said front panel.

2. A display board as recited in claim 1, wherein said front panel includes a plurality of card-holding portions.

3. A display board as recited in claim 1, wherein said display board is a dry-erase board.

4. A display board as recited in claim 3, wherein said dry-erase board is made from a material that permits magnets to be attached hereto.

5. A display board as recited in claim 1, including a frame disposed about lateral sides of said board.

6. A display board as recited in claim 1, including substrate material disposed between said front panel and said rear panel, said substrate material including at least one recess that is indexed with said at least one card-holding portion.

7. A display board comprising:
a front panel having at least one card-holding portion formed therein, said at least one card-holding portion including a plurality of spaced slots, each said slot being sized for retaining at least a portion of a card; and
substrate material disposed beneath said front panel, said substrate material including at least one recess sized for receiving said retained card portions and indexed with said at least one card-holding portion of said front panel.

8. A display board as recited in claim 7, wherein said front panel includes a dry-erase surface.

9. A display board as recited in claim 8, wherein said front panel is made from a material that permits magnets to adhere thereto.

10. A display board as recited in claim 7, including a plurality of card-holding portions, said front panel further including a display surface portion, said surface being made from a dry-erase material.

11. A rotatable kiosk including a base and a rotatable display member, said display member including a plurality of display surfaces and in which at least one of said display surfaces includes a display board according to claim 1.

12. A method for manufacturing a display board, said method comprising the steps of:
forming at least one column of closely-spaced slots defining at least one card-holding portion of a front panel;
forming at least one recess into a substrate material, said at least one recess being sized to receive a portion of a card placed into a closely-spaced slot of said at least one card-holding portion and in which said at least one formed recess is indexed with that of said at least one-card holding portion; and
placing said substrate material beneath said front panel such that each said column and each recess are aligned with one another.

13. A method as recited in claim 12, wherein said front panel is made from steel.

14. A method as recited in claim 12, wherein said indexing step is done simultaneously.

15. A method as recited in claim 12, wherein said front panel includes a display surface portion.

16. A method as recited in claim 15, wherein said display surface portion is defined by a dry-erase surface.
